(19) United States
(12) Patent Application Publication
(10) Pub. No.: US 2025/0234880 A1
(43) Pub. Date: Jul. 24, 2025

(54) FOOD PRODUCT COMPOSITION, AND CHOCOLATE AND MANUFACTURING METHOD THEREFOR

(71) Applicant: Mitsubishi Chemical Corporation, Tokyo (JP)

(72) Inventors: Tomohiro AIBARA, Tokyo (JP); Satoshi ARIMA, Tokyo (JP); Eriko NAITO, Tokyo (JP)

(73) Assignee: Mitsubishi Chemical Corporation, Tokyo (JP)

(21) Appl. No.: 19/176,251

(22) Filed: Apr. 11, 2025

Related U.S. Application Data
(63) Continuation of application No. PCT/JP2023/037306, filed on Oct. 13, 2023.

(30) Foreign Application Priority Data
Oct. 14, 2022 (JP) 2022-165790

(51) Int. Cl. A23G 1/36; A23G 1/40; A23G 1/48

(52) U.S. Cl. CPC A23G 1/36; A23G 1/40; A23G 1/48

(57) ABSTRACT

A food product composition contains a sucrose fatty acid ester in which a fatty acid has 18 or less carbon atoms, a sorbitan fatty acid ester, a laurin-based oil and fat, and a cocoa butter. A chocolate contains the food composition and a method for manufacturing the chocolate contains a step of dissolving a sucrose fatty acid ester in which a fatty acid has 18 or less carbon atoms into a melt containing at least one of a laurin-based oil and fat and a cocoa butter; and a step of dissolving a sorbitan fatty acid ester into the melt containing at least one of the laurin-based oil and fat and the cocoa butter.

### CROSS-REFERENCE TO RELATED APPLICATIONS

This application is a continuation of International Application No. PCT/JP2023/037306, filed on Oct. 13, 2023, and claims the benefit of priority to Japanese Application No. 2022-165790 filed on Oct. 14, 2022. The content of each of these applications is hereby incorporated by reference in its entirety.

### TECHNICAL FIELD

The present invention relates to a food product composition, and a chocolate and a manufacturing method therefor.

### BACKGROUND ART

In the related art, various kinds of fatty food have been incorporated in daily life. Specific examples of the fatty food include a chocolate. The chocolate is manufactured by using cocoa mass, cocoa butter, sugar, milk powder, and the like as main raw materials, mixing these raw materials as appropriate, and subjecting the mixture to processes of rolling (atomization), conching (refining), and tempering (temperature control).

In the manufacture of the chocolate, it is important to transfer an oil and fat such as a cocoa butter in the chocolate to a stable crystal form by a tempering process. For this reason, in industrial production, a step of forcibly cooling a molten chocolate composition and a step of reheating the chocolate composition are performed.

In a chocolate product, a phenomenon where crystals are generated on a surface of the chocolate, which is referred to as a fat bloom, is regarded as a problem. This can occur for example, in a case where the tempering process is insufficient or in a case where a temperature change during storage is large. In a chocolate where a fat bloom is generated, the flavor or the texture are reduced, and the commercial value thereof is reduced.

As a technique for preventing the fat bloom, for example, Patent Literature 1 discloses a fat bloom inhibitor for a chocolate, the fat bloom inhibitor containing a sucrose fatty acid ester as a main component. In the sucrose fatty acid ester, a fatty acid group is mainly a saturated fatty acid group having 12 or less carbon atoms, and an average degree of substitution for sucrose is 4 to 7. By using the fat bloom inhibitor, it is possible to prevent the fat bloom even in a chocolate using a tempered hard butter or a non-tempered hard butter where generation of the fat bloom is particularly significant.

In a non-tempered chocolate disclosed in Patent Literature 2, regarding oils and fats, a content of a cocoa butter is set to 5 mass % to 55 mass %, a content of a laurin-based oil and fat is set to 35 mass % to 90 mass %, and a content of an oil and fat containing a saturated fatty acid having 16 or more carbon atoms in 90 mass % or more is set to 1 mass % to 12 mass %. Accordingly, it is possible to provide a non-tempered chocolate in which a laurin-based oil and fat is used as a base oil. In the non-tempered chocolate, a bloom is less likely to be generated even when a content of a cocoa butter is high.

### CITATION LIST

### Patent Literature

Patent Literature 1: JPH01-39945A
Patent Literature 2: JP2014-103875A

### SUMMARY OF INVENTION

### Technical Problem

However, a higher effect of preventing a fat bloom is desired with respect to the effect of preventing a fat bloom by the fat bloom inhibitor disclosed in Patent Literature 1 or in the non-tempered chocolate disclosed in Patent Literature 2.

Therefore, an object of the present invention is to provide a food product composition in which a fat bloom is less likely to be generated even when a large amount of laurin-based oil and fat is contained therein. Another object of the present invention is to provide a chocolate containing the above food product composition and a manufacturing method therefor.

### Solution to Problem

As a result of intensive studies, the present inventors have found that the above problem can be solved by containing both a sucrose fatty acid ester in which a fatty acid has 18 or less carbon atoms and a sorbitan fatty acid ester in a food product composition containing a laurin-based oil and fat and a cocoa butter, and have completed the present invention.

That is, the present invention relates to the following [1] to [12].
[1] A food product composition containing: a sucrose fatty acid ester in which a fatty acid has 18 or less carbon atoms; a sorbitan fatty acid ester; a laurin-based oil and fat, and a cocoa butter.
[2] The food product composition according to [1], in which the sucrose fatty acid ester has an HLB value of 5 or less.
[3] The food product composition according to [1] or [2], in which the sorbitan fatty acid ester has an HLB value of 5 or less.
[4] The food product composition according to any one of [1] to [3], in which the sucrose fatty acid ester is a sucrose laurate.
[5] The food product composition according to [4], in which a mass ratio of a content of the laurin-based oil and fat to a content of the cocoa butter is 1 to 33.
[6] The food product composition according to [4] or [5], in which a mass ratio of a content of the sucrose laurate to a content of the sorbitan fatty acid ester is 0.1 to 10.
[7] The food product composition according to any one of [4] to [6], in which a mass ratio of a total content of the sucrose laurate and the sorbitan fatty acid ester to a content of the laurin-based oil and fat is 0.002 to 10.
[8] The food product composition according to any one of [1] to [7], further containing an emulsifier other than the sucrose fatty acid ester and the sorbitan fatty acid ester.
[9] The food product composition according to any one of [1] to [8], further containing at least one of a saccharide and a sweetener.
[10] The food product composition according to any one of [1] to [9], further containing a cocoa solid.
[11] A chocolate containing the food product composition according to any one of [1] to [10].
[12] A method for manufacturing the chocolate according to [11], including:
a step of dissolving the sucrose fatty acid ester in which the fatty acid has 18 or less carbon atoms into a melt containing at least one of the laurin-based oil and fat and the cocoa butter; and a step of dissolving the sorbitan fatty acid ester into the melt containing at least one of the laurin-based oil and fat and the cocoa butter.

### Advantageous Effects of Invention

According to the present invention, it is possible to provide a food product composition in which a fat bloom is less likely to be generated even when a large amount of laurin-based oil and fat is contained therein. Therefore, also in a chocolate containing such a food product composition, a fat bloom is less likely to be generated.

### DESCRIPTION OF EMBODIMENTS

Although the present invention will be described in detail below, these contents merely show an example of preferred embodiments, and the present invention is not limited to these contents.

Note that in the present description, “to” indicating a numerical range is used to include the numerical values described before and after it as a lower limit value and an upper limit value.

### [Food Product Composition]

The food product composition according to the present embodiment contains a sucrose fatty acid ester in which a fatty acid has 18 or less carbon atoms, a sorbitan fatty acid ester, a laurin-based oil and fat, and a cocoa butter.

In the related art, it has been common that the sucrose fatty acid ester is superior to the sorbitan fatty acid ester in terms of an effect of preventing a fat bloom (see Patent Literature 1).

However, the present inventors have found that, when a sucrose fatty acid ester in which a fatty acid has 18 or less carbon atoms is used as the sucrose fatty acid ester, and a sorbitan fatty acid ester having a lower effect of preventing a fat bloom than that of the sucrose fatty acid ester is used in combination, the above prevention effect is surprisingly improved on the contrary, and a very good effect of preventing a fat bloom can be realized.

The reason for this is unclear. However, it is considered that the sucrose fatty acid ester in which a fatty acid has 18 or less carbon atoms exhibits an effect of avoiding a change in polymorphism, that is, polymorphic transformation of oil, and the sorbitan fatty acid ester exhibits an effect of avoiding coarsening of an oil and fat, and due to a synergistic effect thereof, the very good effect of preventing a fat bloom in the present embodiment can be realized.

A fat bloom in the present description is a phenomenon in which crystals are generated on a surface of a food product composition such as a chocolate. The fat bloom is likely to be generated, for example, in a case where a chocolate flavor is increased by blending a large amount of cocoa butter or cocoa mass in a chocolate containing a laurin-based hard butter or in a case where a temperature change during storage is large.

In a food product composition, such as a chocolate, in which a fat bloom is generated, the flavor or the texture are reduced, and the commercial value thereof is reduced.

Among food product compositions, it is considered that the fat bloom in the chocolate is caused by a change in crystal form of an oil and fat in the chocolate. That is, although an oil and fat such as a cocoa butter is used as a raw oil and fat, in order to adjust a crystal form of the oil and fat, an oil and fat crystal in the chocolate may exist as a stable V-shaped crystal. During storage, the V-shaped crystal of the cocoa butter is transferred to a VI-shaped crystal which is the most stable polymorphism, and this crystal growth may cause a fat bloom.

The fat bloom is generated when the chocolate is placed under a storage condition or a distribution condition where changes from a high temperature to a low temperature. The fat bloom is further likely to be generated when the above temperature change is large. That is, due to melting of a surface of the chocolate, and melting of a part of an unstable crystal of the chocolate and transferring to the surface, melted oils and fats are crystallized on the surface of the chocolate, and by repeating crystal growth, the oils and fats are gradually coarsened to become a fat bloom.

The sucrose fatty acid ester in the present embodiment is an ester composed of a sucrose having a hydrophilic group and a fatty acid having a lipophilic group having 18 or less carbon atoms, and is used as an emulsifier.

Since the food product composition according to the present embodiment contains the cocoa butter and the laurin-based oil and fat, the above specific sucrose fatty acid ester is preferably lipophilic, and preferably has a low HLB (hydrophile-lipophile balance) value.

The HLB value in the present description means a relative strength of hydrophilicity and lipophilicity of a surfactant molecule, and indicates a balance thereof in quantity. The higher the HLB value, the greater the water solubility, and the lower the HLB value, the greater the lipophilicity.

An HLB value of the sucrose fatty acid ester is preferably 5 or less, more preferably 4 or less, and further preferably 2 or less from the viewpoint of solubility in an oil and fat. In addition, the lower limit of the above HLB value is not particularly limited, and the HLB value is generally 0 or more.

A sucrose constituting the specific sucrose fatty acid ester may be a commercially available product or a synthesized product, or may be a recovered product of a reaction during manufacture, that is, so-called recovered sucrose.

In addition, the sucrose fatty acid ester itself may also be a commercially available product or a synthesized product.

The number of carbon atoms of the fatty acid of the sucrose fatty acid ester in the present embodiment is 18 or less, and is preferably 16 or less, more preferably 14 or less, and further preferably 12 or less from the viewpoint of compatibility with the laurin-based oil and fat. In addition, the lower limit of the number of carbon atoms is not particularly limited, and the number of carbon atoms is, for example, 6 or more.

As the sucrose fatty acid ester, for example, a sucrose laurate a sucrose palmitate, and a sucrose stearate are preferable, and the sucrose laurate is more preferable.

A content of the sucrose fatty acid ester in the food product composition according to the present embodiment is preferably an amount within a specific range from the viewpoint of preventing a fat bloom. Specifically, the content is preferably 0.1 mass % or more, more preferably 0.15 mass % or more, and further preferably 0.2 mass % or more, while on the other hand, is preferably 5 mass % or less, more preferably 4 mass % or less, and further preferably 3 mass % or less. Therefore, the content of the sucrose laurate is preferably 0.1 mass % to 5 mass %, more preferably 0.15 mass % to 4 mass %, and further preferably 0.2 mass % to 3 mass %.

Similarly, in a case where the sucrose fatty acid ester is the sucrose laurate, a content of the sucrose laurate in the food product composition according to the present embodiment is also preferably an amount within a specific range from the viewpoint of preventing a fat bloom. Specifically, the content is preferably 0.1 mass % or more, more preferably 0.15 mass % or more, and further preferably 0.2 mass % or more, while on the other hand, is preferably 5 mass % or less, more preferably 4 mass % or less, and further preferably 3 mass % or less. Therefore, the content of the sucrose laurate is preferably 0.1 mass % to 5 mass %, more preferably 0.15 mass % to 4 mass %, and further preferably 0.2 mass % to 3 mass %.

In the sorbitan fatty acid ester in the present embodiment, the fatty acid may be a saturated fatty acid or an unsaturated fatty acid. From the viewpoint of preventing a fat bloom, a sorbitan saturated fatty acid ester is preferable.

More specifically, a sorbitan monostearate, a sorbitan distearate, a sorbitan tristearate, a sorbitan monobehenate, a sorbitan dibehenate, and a sorbitan tribehenate are preferable, the sorbitan tristearate and the sorbitan tribehenate are more preferable, and the sorbitan tristearate is further preferable.

By adding an appropriate amount of an appropriate sorbitan fatty acid ester, the effect of preventing a fat bloom is remarkably enhanced.

An HLB value of the above sorbitan fatty acid ester is preferably 5 or less, more preferably 4 or less, and further preferably 3 or less from the viewpoint of solubility in an oil and fat. In addition, the lower limit of the above HLB value is not particularly limited, and the HLB value is generally 0 or more.

Further, it is more preferable that the HLB value of the specific sucrose fatty acid ester being 5 or less and the HLB value of the sorbitan fatty acid ester being 5 or less are both satisfied.

A content of the sorbitan fatty acid ester in the food product composition according to the present embodiment is preferably equal to or larger than a certain amount from the viewpoint of preventing a fat bloom. Specifically, the content is preferably 0.1 mass % or more, more preferably 0.15 mass % or more, and further preferably 0.2 mass % or more. On the other hand, the content of the sorbitan fatty acid ester is preferably equal to or smaller than a certain amount from the viewpoint of preventing a fat bloom. Specifically, the content is preferably 5 mass % or less, more preferably 4 mass % or less, and further preferably 3 mass % or less. That is, the content of the sorbitan fatty acid ester is preferably 0.1 mass % to 5 mass %, more preferably 0.15 mass % to 4 mass %, and further preferably 0.2 mass % to 3 mass %.

In a case where the food product composition according to the present embodiment contains two or more kinds of sorbitan fatty acid esters, a total content thereof is preferably within the above range.

The laurin-based oil and fat in the present embodiment is an oil and fat having a lauric acid content of 30 mass % or more in a constituent fatty acid.

The laurin-based oil and fat is also called a lauric acid-based hard butter. The lauric acid-based hard butter is classified as a non-tempered hard butter.

In a case where the food product composition according to the present embodiment is a chocolate, a chocolate using the non-tempered hard butter as a base oil is classified as a non-tempered chocolate.

For the non-tempered chocolate, a complicated tempering process is not required and workability is good, and thus the non-tempered chocolate is widely used as a chocolate for confectionery and bread baking. Among them, as a chocolate for covering confectionery and bread, a chocolate using a laurin-based oil and fat as a base oil is widely used because it is inexpensive and has an excellent in-mouth melting feeling.

The lauric acid content in the constituent fatty acid of the laurin-based oil and fat is 30 mass % or more, and is preferably 30 mass % to 60 mass %, and more preferably 40 mass % to 60 mass %. Here, from the viewpoint of a laurin-based oil and fat for chocolate, the lauric acid content is preferably 40 mass % or more. In addition, from the viewpoint of the laurin-based oil and fat for chocolate, the lauric acid content is preferably 60 mass % or less.

Examples of the laurin-based oil and fat include palm kernel oil, coconut oil, and processed oils and fats thereof. Examples of the processed oil and fat include fractionated oil, hardened oil (hydrogenated oil), and transesterified oil and fat.

A relative content of the laurin-based oil and fat in the food product composition according to the present embodiment with respect to 100 parts by mass of a total amount of the specific sucrose fatty acid ester, the sorbitan fatty acid ester, the laurin-based oil and fat, and the cocoa butter which are contained in the food product composition according to the present embodiment is preferably 60 parts by mass to 98 parts by mass, more preferably 65 parts by mass to 93 parts by mass, and further preferably 70 parts by mass to 85 parts by mass. Here, from the viewpoint of preventing a bloom, the relative content of the laurin-based oil and fat is preferably 60 parts by mass or more, more preferably 65 parts by mass or more, and further preferably 70 parts by mass or more. In addition, from the viewpoint of preventing a bloom, the relative content of the laurin-based oil and fat is preferably 98 parts by mass or less, more preferably 90 parts by mass or less, and further preferably 85 parts by mass or less.

In a case where the food product composition according to the present embodiment contains two or more kinds of laurin-based oil and fats, a total content thereof is preferably within the above range.

In addition, in a case where the specific sucrose fatty acid ester is a sucrose laurate, a preferred range of the relative content of the laurin-based oil and fat is the same as the above range.

The cocoa butter in the present embodiment is a component contained in the cocoa mass or the cocoa powder. The cocoa butter is obtained by processing the cocoa mass in accordance with a common method.

The cocoa mass is a component obtained by grinding an endosperm (cocoa nib) obtained by crushing cocoa beans and removing shells and embryos of the cocoa beans.

In the present description, the term cocoa butter encompasses a cocoa butter derived from an oil-containing raw material in addition to a cocoa butter itself. That is, in a case where an oil-containing raw material such as a cocoa mass or a cocoa powder is added to manufacture a food product composition, a cocoa butter contained in the oil-containing raw material is also encompassed within the term cocoa butter.

The cocoa butter is desired to be blended in a large amount in order to obtain a rich flavor of the food product composition. On the other hand, as represented by the non-tempered chocolate, in the food product composition containing both the cocoa butter and the laurin-based oil and fat, the compatibility of the cocoa butter and the laurin-based oil and fat is poor, and a fat bloom is likely to be generated. Therefore, it is difficult to blend a large amount of a cocoa mass containing a large amount of cocoa butter or a cocoa butter itself together with the laurin-based oil and fat. As a result, there has been an actual situation that the food product composition containing the laurin-based oil and fat such as the non-tempered chocolate is inferior in flavor.

In contrast, in the food product composition according to the present embodiment, the generation of a fat bloom can be prevented by using the specific sucrose fatty acid ester and the sorbitan fatty acid ester in combination. Therefore, the cocoa butter can be blended in a larger amount than in the related art, and a food product composition having a rich flavor can be obtained.

The content of the cocoa butter in the food product composition according to the present embodiment is preferably large from the viewpoint of obtaining a rich flavor of the food product composition. Specifically, a relative content of the cocoa butter with respect to 100 parts by mass of the total amount of the specific sucrose fatty acid ester, the sorbitan fatty acid ester, the laurin-based oil and fat, and the cocoa butter which are contained in the food product composition according to the present embodiment is preferably 2 parts by mass or more, more preferably 7 parts by mass or more, and further preferably 15 parts by mass or more. On the other hand, from the viewpoint of preventing the generation of a fat bloom, the content of the cocoa butter is preferably small. Specifically, the relative content is preferably 40 parts by mass or less, more preferably 35 parts by mass or less, and further preferably 30 parts by mass or less. Therefore, the content of the cocoa butter is preferably 2 parts by mass to 40 parts by mass, more preferably 7 parts by mass to 35 parts by mass, and further preferably 15 parts by mass to 30 parts by mass.

In addition, in the case where the sucrose fatty acid ester is a sucrose laurate, a preferred range of the relative content of the cocoa butter is the same as the above range.

A mass ratio of the content of the laurin-based oil and fat to the content of the cocoa butter, that is, a mass ratio represented by (laurin-based oil and fat/cocoa butter), is preferably within a certain range from the viewpoint of obtaining a richer flavor and making it difficult to generate a fat bloom. Specifically, the mass ratio is preferably 1 or more, more preferably 1.5 or more, and further preferably 1.8 or more, while on the other hand, is preferably 33 or less, more preferably 24 or less, and further preferably 18 or less. That is, the mass ratio represented by laurin-based oil and fat/cocoa butter is preferably 1 to 33, more preferably 1.5 to 24, and further preferably 1.8 to 18.

In the case where the sucrose fatty acid ester is a sucrose laurate, a preferable range of the mass ratio represented by (laurin-based oil and fat/cocoa butter) is the same as the above range.

A mass ratio of the content of the sucrose fatty acid ester to the content of the sorbitan fatty acid ester, that is, a mass ratio represented by (sucrose fatty acid ester/sorbitan fatty acid ester), is preferably within a certain range from the viewpoint of preventing a fat bloom. Specifically, the mass ratio is preferably 0.1 or more, more preferably 0.2 or more, and further preferably 0.5 or more, while on the other hand, is preferably 10 or less, more preferably 9 or less, further preferably 8 or less, even more preferably 5 or less, particularly preferably 3 or less, and most preferably 2 or less. That is, the mass ratio represented by sucrose fatty acid ester/sorbitan fatty acid ester is preferably 0.1 to 10, more preferably 0.1 to 9, further preferably 0.2 to 8, even more preferably 0.2 to 5, particularly preferably 0.5 to 3, and most preferably 0.5 to 2.

In addition, in the case where the sucrose fatty acid ester is a sucrose laurate, a preferred range of the mass ratio of the above contents is the same as the above range.

A total content of the specific sucrose fatty acid ester and the sorbitan fatty acid ester in the food product composition according to the present embodiment is preferably within a certain range from the viewpoint of an effect of preventing a bloom. Specifically, the total content is preferably 0.1 mass % or more, more preferably 0.15 mass % or more, further preferably 0.2 mass % or more, even more preferably 0.3 mass % or more, and particularly preferably 0.5 mass % or less. On the other hand, the total content is preferably 10 mass % or less, more preferably 6 mass % or less, further preferably 5 mass % or less, and particularly preferably 1 mass % or less. That is, the total content is preferably 0.1 mass % to 10 mass %, more preferably 0.15 mass % to 6 mass %, further preferably 0.2 mass % to 6 mass %, even more preferably 0.3 mass % to 5 mass %, and particularly preferably 0.5 mass % to 1 mass %.

In addition, in the case where the sucrose fatty acid ester is a sucrose laurate, a preferred range of the total content is the same as the above range.

A mass ratio of the total content of the specific sucrose fatty acid ester and the sorbitan fatty acid ester to the content of the laurin-based oil and fat, that is, a mass ratio represented by {(sucrose fatty acid ester+sorbitan fatty acid ester)/laurin-based oil and fat}, is preferably within a certain range from the viewpoint of preventing the generation of a fat bloom. Specifically, the mass ratio is preferably 0.002 or more, more preferably 0.008 or more, and further preferably 0.015 or more, while on the other hand, is preferably 10 or less, more preferably 1 or less, further preferably 0.222 or less, particularly preferably 0.2 or less, and most preferably 0.15 or less. That is, the mass ratio is preferably 0.002 to 10, more preferably 0.002 to 1, further preferably 0.008 to 0.222, even more preferably 0.008 to 0.2, and particularly preferably 0.015 to 0.15.

In addition, in the case where the sucrose fatty acid ester is a sucrose laurate, a preferred range of the mass ratio of the above contents is the same as the above range.

The food product composition according to the present embodiment may contain other components in addition to the specific sucrose fatty acid ester, the sorbitan fatty acid ester, the laurin-based oil and fat, and the cocoa butter, as long as the effect of the present invention is not impaired.

Examples of the other components include other fat bloom inhibitors, emulsifiers, saccharides, sweeteners, cocoa components other than the cocoa butter such as cocoa solids, milk components, flavors, oils and fats, seeding agents, antioxidants, colorants, various kinds of powder, and starches. In addition, a sucrose fatty acid ester other than the sucrose laurate may be contained.

As the other fat bloom inhibitors, those which are common in the related art can be used. Examples thereof include a polysorbate 60, a polyglycerol fatty acid ester, and a monoglycerol fatty acid ester. Only one type thereof may be used, or two or more types thereof may be used.

In a case where these other fat bloom inhibitors are contained, a total content of the other fat bloom inhibitors in the food product composition according to the present embodiment is preferably large from the viewpoint that an effect of the other fat bloom inhibitors is easily exhibited. Specifically, the total content is preferably 0.1 mass % or more, more preferably 0.15 mass % or more, and further preferably 0.2 mass % or more. On the other hand, the total content is preferably small from the viewpoint of easily exhibiting a bloom prevention effect, and specifically, the total content is preferably 5 mass % or less, more preferably 4 mass % or less, and further preferably 3 mass % or less. Therefore, the total content is preferably 0.1 mass % to 5 mass %, more preferably 0.15 mass % to 4 mass %, and further preferably 0.2 mass % to 3 mass %.

In addition, in the case where these other fat bloom inhibitors are contained, a total content of the specific sucrose fatty acid ester and the sorbitan fatty acid ester which are contained in the food product composition according to the present embodiment is preferably 50 mass % or more with respect to a total amount of the fat bloom inhibitors contained in the food product composition according to the present embodiment. In addition, in the case where the sucrose fatty acid ester is a sucrose laurate, the total content is also preferably 50 mass % or more with respect to the total amount of the fat bloom inhibitors contained in the food product composition according to the present embodiment.

The emulsifier means the other emulsifier(s) than the specific sucrose fatty acid ester and the sorbitan fatty acid ester.

As the other emulsifier, an emulsifier which is common in the related art can be used, and examples thereof preferably include lecithin, lysolecithin, enzyme-decomposed lecithin, polyglycerin condensed ricinoleic acid ester, polyglycerin fatty acid ester, and the like. Only one kind thereof may be used, or two or more kinds thereof may be used.

In a case where the other emulsifiers are contained, a total content of the other emulsifiers in the food product composition according to the present embodiment is preferably large from the viewpoint of suitably obtaining an effect of the other emulsifiers. Specifically, the total content is preferably 0.01 mass % or more, more preferably 0.05 mass % or more, and further preferably 0.1 mass % or more. On the other hand, the total content is preferably small from the viewpoint of preventing a bloom. Specifically, the total content is preferably 5 mass % or less, more preferably 3 mass % or less, further preferably 2 mass % or less, even more preferably 0.7 mass % or less, particularly preferably 0.6 mass % or less, and most preferably 0.5 mass % or less. That is, the total content is preferably 0 mass % to 5 mass %, more preferably 0.01 mass % to 3 mass %, further preferably 0.05 mass % to 2 mass %, even more preferably 0.1 mass % to 0.7 mass %, particularly preferably 0.1 mass % to 0.6 mass %, and most preferably 0.1 mass % to 0.5 mass %.

The food product composition according to the present embodiment may further contain at least one of a saccharide and a sweetener.

As the saccharide and the sweetener, those which are common in the related art can be used, and examples of the saccharide include sucrose (sugar, sugar powder), lactose, glucose, fructose, and maltose. Examples of the sweetener include sorbitol, reducing lactose, trehalose, xylose, xylitose, maltitol, erythritol, mannitol, raffinose, and dextrin. One kind thereof may be used, or two or more kinds thereof may be used.

In a case where the sucrose (sugar, sugar powder) is contained as a saccharide, a content of the sucrose in the food product composition according to the present embodiment is preferably large from the viewpoint of imparting appropriate sweetness to the food product composition. Specifically, in the case where the sucrose is contained, the content thereof is preferably 20 mass % or more, and more preferably 25 mass % or more. On the other hand, the content is preferably small from the viewpoint of flavor. Specifically, the content is preferably 60 mass % or less, and more preferably 55 mass % or less. That is, the content is preferably 0 mass % to 60 mass %, more preferably 20 mass % to 60 mass %, and further preferably 25 mass % to 55 mass %.

In a case where at least one selected from the group consisting of lactose, glucose, fructose, and maltose is contained as the saccharide, a total content of the saccharides in the food product composition according to the present embodiment is preferably large from the viewpoint of imparting suitable sweetness to the food product composition. Specifically, in the case where the saccharides are contained, the total content thereof is preferably 5 mass % or more, and more preferably 10 mass % or more. On the other hand, the total content is preferably small from the viewpoint of flavor. Specifically, the total content is preferably 60 mass % or less, and more preferably 55 mass % or less. That is, the total content is preferably 0 mass % to 60 mass %, more preferably 5 mass % to 55 mass %, and further preferably 10 mass % to 55 mass %.

In a case where the sweetener is contained, a total content of the sweetener in the food product composition according to the present embodiment is preferably large from the viewpoint of imparting suitable sweetness to the food product composition. Specifically, in the case where the sweetener is contained, the total content thereof is preferably 1 mass % or more, and more preferably 3 mass % or more. On the other hand, the total content is preferably small from the viewpoint of flavor. Specifically, the total content is preferably 60 mass % or less, and more preferably 55 mass % or less. That is, the total content is preferably 0 mass % to 60 mass %, more preferably 1 mass % to 55 mass %, and further preferably 3 mass % to 55 mass %.

In addition, a total content of the saccharide and the sweetener in the food product composition according to the present embodiment is preferably large from the viewpoint of imparting suitable sweetness to the food product composition. Specifically, the total content is preferably 1 mass % or more, more preferably 3 mass % or more, and further preferably 5 mass % or more. On the other hand, the total content is preferably small from the viewpoint of flavor. Specifically, the total content is preferably 70 mass % or less, more preferably 60 mass % or less, and further preferably 55 mass % or less.

The food product composition according to the present embodiment may further contain a cocoa solid. The cocoa solid means a component excluding the cocoa butter from components constituting the cocoa mass and the cocoa powder.

A content of the cocoa solid in the food product composition according to the present embodiment is preferably 80 mass % or less, more preferably 75 mass % or less, and further preferably 70 mass % or less.

In addition, examples of a cocoa component other than the cocoa solid and the cocoa butter include a cacao nib and a cocoa cake.

As the milk component, a milk component which is common in the related art can be used. Examples thereof include non-fat dry milk powder and whole milk powder. One kind thereof may be used, or two or more kinds thereof may be used.

A total content of the milk component in the food product composition according to the present embodiment is preferably within a certain range from the viewpoint of flavor. Specifically, in the case where the milk component is contained, the total content thereof is preferably 2 mass % or more, and more preferably 4 mass % or more, while on the other hand, is preferably 45 mass % or less, more preferably 40 mass % or less, and further preferably 35 mass % or less. That is, the total content of the milk components is preferably 45 mass % or less, more preferably 2 mass % to 40 mass %, and further preferably 4 mass % to 35 mass %.

The food product composition according to the present embodiment can be included in a food such as a chocolate and a curry roux.

### [Chocolate]

The chocolate according to the present embodiment contains the food product composition described in the above [food product composition].

That is, the chocolate according to the present embodiment contains the sucrose fatty acid ester in which a fatty acid has 18 or less carbon atoms, the sorbitan fatty acid ester, the laurin-based oil and fat, and the cocoa butter, and a content of the laurin-based oil and fat with respect to a content of the cocoa butter is 1 to 33 in mass ratio. In the chocolate according to the present embodiment, a content of the food product composition is preferably 50 mass % or more, more preferably 70 mass % or more, further preferably 80 mass % or more, and particularly preferably 90 mass % or more. In addition, the content may be 100 mass %, that is, the chocolate is composed only of the food product composition.

The chocolate in the present description is not limited by the “fair competition code related to display of chocolates” (national chocolate industry fair trade council) or legal provisions. It means a chocolate manufactured through chocolate manufacturing steps (all or some of mixing step, atomization step, refining step, molding step, cooling step, and the like) by using edible oils and fats and saccharides as main raw materials and optionally adding cocoa components (cocoa mass, cocoa powder, and the like), a milk product, a flavor, an emulsifier, and the like.

Examples of the chocolate according to the present embodiment include a white chocolate and a colored chocolate in addition to a dark chocolate and a milk chocolate.

A preferred embodiment of the chocolate according to the present embodiment is the same as a preferred embodiment of the food product composition described in the above [food product composition]. In addition, a content of oils and fats in the chocolate preferably satisfies a specific range to be described below.

The oils and fats in a chocolate mean edible oils and fats. The edible oils and fats are not particularly limited, and examples thereof include soybean oil, rapeseed oil, palm oil, corn oil, rice bran oil, fish oil, beef tallow, pork tallow, milk fat, cocoa butter, sal butter, shea butter, illipe fat, palm kernel oil, coconut oil, hardened oils of these, as well as shirashime oil, fractionated oil, and transesterified oil and fat. Examples of the edible oils and fats also include oils and fats contained in a cocoa mass, cocoa powder, whole milk powder, or nuts such as a peanut paste, which are solid components. The laurin-based oil and fat in the present embodiment is included in the above oils and fats.

A total content of the oils and fats in the chocolate according to the present embodiment is preferably within a specific range from the viewpoint of in-mouth melting feeling. Specifically, in the case where the oils and fats are contained, the total content thereof is preferably 25 mass % or more, and more preferably 30 mass % or more, while on the other hand, is preferably 55 mass % or less, more preferably 50 mass % or less, and further preferably 45 mass % or less. That is, the total content is preferably 25 mass % to 55 mass %, more preferably 30 mass % to 50 mass %, and further preferably 30 mass % to 45 mass %.

### [Method for Manufacturing Chocolate]

The method for manufacturing a chocolate according to the present embodiment is not particularly limited as long as the chocolate described in the above [chocolate] can be obtained.

As a preferred embodiment, the manufacturing method according to the present embodiment includes the following steps.

It is preferable that the sucrose fatty acid ester in which a fatty acid has 18 or less carbon atoms and the sorbitan fatty acid ester are dissolved into a melt of the laurin-based oil and fat or the cocoa butter. Therefore, the method for manufacturing a chocolate according to the present embodiment preferably includes a step of dissolving the specific sucrose fatty acid ester into a melt containing at least one of the laurin-based oil and fat and the cocoa butter, and a step of dissolving the sorbitan fatty acid ester into the melt containing at least one of the laurin-based oil and fat and the cocoa butter.

The method for manufacturing a chocolate generally includes all or some of a mixing step, an atomization step, a refining step, a molding step, and a cooling step.

In the manufacturing method according to the present embodiment, for example, in at least one of the mixing step and the refining step among the above steps, it is preferable to add the specific sucrose fatty acid ester or the sorbitan fatty acid ester to a melt in which at least one of the laurin-based oil and fat and the cocoa butter is in a molten state, and dissolve them.

By adding the sucrose fatty acid ester and the sorbitan fatty acid ester to the melt of the laurin-based oil and fat or the cocoa butter, the sucrose fatty acid ester, the sorbitan fatty acid ester, the laurin-based oil and fat, and the cocoa butter are easily uniformly mixed, and the homogeneity of the obtained chocolate becomes very high. As a result, the generation of a fat bloom can be more suitably prevented. In the manufacturing method according to the present embodiment, the sucrose fatty acid ester is preferably a sucrose laurate, similar to the sucrose fatty acid ester described in the above [food product composition], and a more preferred embodiment thereof is also similar thereto.

The melt to which the specific sucrose fatty acid ester and the sorbitan fatty acid ester are added may be a melt of the laurin-based oil and fat, a melt of the cocoa butter, or a melt of the laurin-based oil and fat and the cocoa butter.

The melt may contain, for example, other components such as other fat bloom inhibitors, emulsifiers, saccharides, sweeteners, cocoa components other than the cocoa butter such as cocoa solids, milk components, flavors, oils and fats, seeding agents, antioxidants, colorants, various kinds of powder, and starches.

As for the specific sucrose fatty acid ester and the sorbitan fatty acid ester to be added, the sucrose fatty acid ester and the sorbitan fatty acid ester may be added separately or simultaneously, or a mixture of the sucrose fatty acid ester and the sorbitan fatty acid ester may be added.

In the case where the sucrose fatty acid ester and the sorbitan fatty acid ester are added separately, the melt to which the sucrose fatty acid ester and the sorbitan fatty acid ester are added may be the same or different. Examples of the expression of “the melt to which the sucrose fatty acid ester and the sorbitan fatty acid ester are added being different” include: a case where the specific sucrose fatty acid ester is added to the melt of the laurin-based oil and fat and the sorbitan fatty acid ester is added to the melt of the cocoa butter; and a case where the sorbitan fatty acid ester is added to the melt of the laurin-based oil and fat and the specific sucrose fatty acid ester is added to the melt of the cocoa butter.

In the case where the sucrose fatty acid ester and the sorbitan fatty acid ester are added separately, steps of adding them may be different in such a manner that one of the specific sucrose fatty acid ester and the sorbitan fatty acid ester is added in the mixing step and the other is added in the refining step.

Further, each of the specific sucrose fatty acid ester and the sorbitan fatty acid ester may be added in two or more sessions.

### EXAMPLES

Hereinafter, the present invention will be described in more detail using Examples, but the present invention is not limited to the following Examples unless it departs from the gist thereof.

### Example 1

0.25 parts by mass of a sucrose laurate (Ryoto sugar ester L-195, manufactured by Mitsubishi Chemical Corporation), 0.50 parts by mass of a sorbitan tristearate (GRINDSTED STSQ, manufactured by Danisco Malaysia Sdn.Bhd.), 12.50 parts by mass of cocoa powder (Aztec cocoa powder PG12, manufactured by Meiji Co., Ltd.), 3.00 parts by mass of a cocoa mass (NK quick cocoa mass, manufactured by NISSHIN KAKO CO., LTD.), 50.60 parts by mass of a sugar (pure sugar, manufactured by TOMIZAWA SHOUTEN), 33.60 parts by mass of a laurin-based oil and fat (ISFATH2100G, manufactured by Nisshin OilliO Group, Ltd.), and 0.30 parts by mass of lecithin (SLP-paste, manufactured by Tsuji Oil Mills Co., Ltd.) were mixed in a mixer, then the mixture was introduced into a melanger and atomized to obtain a chocolate dough. In this case, a sucrose laurate and the sorbitan tristearate which is a sorbitan fatty acid ester was dissolved in a melt containing a laurin-based oil and fat and a cocoa butter. Thereafter, the chocolate dough whose temperature had been adjusted to 45° C. was poured into a round mold (A-5007, manufactured by Atelier House Co., Ltd., 7 g per a mold), and cooled and solidified at 6° C. for 30 minutes to obtain a chocolate composed of only food product compositions.

In Table 1, addition amounts of the above raw materials are described as “recipe (part by mass)”. Among these, for respective components of the cocoa butter, the laurin-based oil and fat, the sucrose fatty acid ester, and the sorbitan fatty acid ester, a content ratio of each of the components with respect to a total of the four components is described as “content ratio (mass %)”. In Table 1, “-” means not added.

Table 1 also shows a mass ratio of a content of the laurin-based oil and fat to a content of the cocoa butter, a mass ratio of a content of the sucrose laurate to a content of the sorbitan fatty acid ester, and a mass ratio of a total content of the sucrose laurate and the sorbitan fatty acid ester to the content of the laurin-based oil and fat.

### Comparative Example 1

A chocolate composed of only food product compositions was obtained in the same manner as in Example 1 except that the sucrose laurate was not used.

### Comparative Example 2

A chocolate composed of only food product compositions was obtained in the same manner as in Example 1 except that the sucrose laurate was not used and the addition amount of the sorbitan tristearate was changed to 0.75 parts by mass.

### Example 2

A chocolate composed of only food product compositions was obtained in the same manner as in Example 1, except that 0.25 parts by mass of a sucrose stearic acid ester (Ryoto sugar ester S-170, manufactured by Mitsubishi Chemical Corporation) was added instead of the sucrose laurate.

### Example 3

A chocolate composed of only food product compositions was obtained in the same manner as in Example 1, except that 0.25 parts by mass of a sucrose mixed fatty acid ester (Ryoto sugar ester POS-135, manufactured by Mitsubishi Chemical Corporation, mixed fatty acids having 18 and 16 carbon atoms) was added instead of the sucrose laurate.

### Comparative Example 3

A chocolate composed of only food product compositions was obtained in the same manner as in Example 1 except that the sorbitan tristearate was not used and the addition amount of the sucrose laurate was changed to 0.50 parts by mass.

### Comparative Example 4

A chocolate composed of only food product compositions was obtained in the same manner as in Example 1 except that the sucrose laurate and the sorbitan tristearate were not used.

### Example 4

A chocolate composed of only food product compositions was obtained in the same manner as in Example 1 except that the cocoa mass was not used and contents of other components were as shown in Table 1.

### Example 5

A chocolate composed of only food product compositions was obtained in the same manner as in Example 1 except that contents of the respective components were as shown in Table 1.

### [Evaluation: Fat Bloom]

The obtained chocolate was stored for 9 weeks in a thermostatic bath (IQ822, manufactured by Yamato Scientific Co., ltd.) at 15° C., and then subjected to visual observation for presence or absence of generation of a fat bloom. The generation of a fat bloom was evaluated according to the following criteria, and results thereof are shown in Table 1.
A: Generation of a fat bloom was not observed.
B: A fat bloom was slightly generated.
C: A fat bloom was generated.

In the case of “A” in which the generation of a fat bloom was not observed, it can be determined that the fat bloom was very suitably prevented for a long period of time. A difference between “B” and “C” was that it is evaluated as “B” when an area of the fat bloom generated on a surface of the chocolate was about one-third or less, and it is evaluated as “C” when the area was more than one-third. When the evaluation is “A” or “B”, it can be determined as acceptable.

### [Evaluation: Bloom Generation Period]

The obtained chocolate was stored in a thermostatic bath (IQ822, manufactured by Yamato Scientific Co., ltd.) at 15° C., and a period (number of days) until the fat bloom was generated was measured by visual observation. The chocolate was stored for up to 100 days.

It can be said that the number of days until the fat bloom was generated is preferably 30 days or more, more preferably 50 days or more, further preferably 70 days or more, and particularly preferably more than 100 days. The results are shown in Table 1.

TABLE 1

| | | Example | Comparative | Comparative | Example | Example | Comparative | Comparative | Example | Example |
|---|---|---|---|---|---|---|---|---|---|---|
| | | 1 | Example 1 | Example 2 | 2 | 3 | Example 3 | Example 4 | 4 | 5 |
| Recipe | Cocoa | 12.50 | 12.50 | 12.50 | 12.50 | 12.50 | 12.50 | 12.50 | 15.00 | 14.00 |
| (part | powder | | | | | | | | | |
| by | Cocoa | 3.00 | 3.00 | 3.00 | 3.00 | 3.00 | 3.00 | 3.00 | — | 1.50 |
| mass) | mass | | | | | | | | | |
| | Sugar | 50.60 | 50.60 | 50.60 | 50.60 | 50.60 | 50.60 | 50.60 | 50.00 | 50.00 |
| | Laurin- | 33.60 | 33.60 | 33.60 | 33.60 | 33.60 | 33.60 | 33.60 | 35.00 | 34.50 |
| | based | | | | | | | | | |
| | oil and | | | | | | | | | |
| | fat | | | | | | | | | |
| | Lecithin | 0.30 | 0.30 | 0.30 | 0.30 | 0.30 | 0.30 | 0.30 | 0.30 | 0.30 |
| | Sorbitan | 0.50 | 0.50 | 0.75 | 0.50 | 0.50 | — | — | 0.25 | 0.25 |
| | fatty | | | | | | | | | |
| | acid | | | | | | | | | |
| | ester | | | | | | | | | |
| | Sucrose | 0.25 | — | — | — | — | 0.50 | — | 0.25 | 0.25 |
| | lauric | | | | | | | | | |
| | acid | | | | | | | | | |
| | ester | | | | | | | | | |
| | Sucrose | — | — | — | 0.25 | — | — | — | — | — |
| | stearic | | | | | | | | | |
| | acid | | | | | | | | | |
| | ester | | | | | | | | | |
| | Sucrose | — | — | — | — | 0.25 | — | — | — | — |
| | mixed | | | | | | | | | |
| | fatty | | | | | | | | | |
| | acid | | | | | | | | | |
| | lester | | | | | | | | | |

| | | Example | Comparative | Comparative | Example | Example | Comparative | Comparative | Example | Example |
|---|---|---|---|---|---|---|---|---|---|---|
| | | 1 | Example 1 | Example 2 | 2 | 3 | Example 3 | Example 4 | 4 | 5 |
| Content | Cocoa butter | 8.09 | 8.15 | 8.09 | 8.09 | 8.09 | 8.15 | 8.26 | 4.44 | 6.33 |
| ratio | Laurin-based | 89.90 | 90.51 | 89.90 | 89.90 | 89.90 | 90.51 | 91.74 | 94.21 | 92.33 |
| (mass %) | oil and fat | | | | | | | | | |
| | Sucrose lauric | 0.67 | — | — | — | — | 1.35 | — | 0.67 | 0.67 |
| | acid ester | | | | | | | | | |
| | Sucrose | — | — | — | 0.67 | 0.67 | — | — | — | — |
| | (stearic | | | | | | | | | |
| | acid/mixed | | | | | | | | | |
| | fatty acid) | | | | | | | | | |
| | ester | | | | | | | | | |
| | Sorbitan fatty | 1.34 | 1.35 | 2.01 | 1.34 | 1.34 | — | — | 0.67 | 0.67 |
| | acid ester | | | | | | | | | |

| | | | | | | | | | |
|---|---|---|---|---|---|---|---|---|---|
| Laurin-based oil and | 11.11 | 11.11 | 11.11 | 11.11 | 11.11 | 11.11 | 11.11 | 21.21 | 14.59 |
| fat/cocoa butter | | | | | | | | | |
| Specific sucrose fatty | 0.50 | — | — | 0.50 | 0.50 | — | — | 1.00 | 1.00 |
| acid ester/sorbitan fatty | | | | | | | | | |
| acid ester | | | | | | | | | |
| Specific sucrose fatty | 0.022 | 0.015 | 0.022 | 0.022 | 0.022 | — | — | 0.014 | 0.014 |
| acid ester + sorbitan | | | | | | | | | |
| fatty acid ester | | | | | | | | | |
| Laurin-based oil and fat | | | | | | | | | |
| Bloom evaluation | A | C | C | B | B | C | C | A | A |
| Bloom generation | 77 | 27 | 45 | 56 | 56 | 27 | 27 | >100 | >100 |
| period (day) | | | | | | | | | |

As can be seen from the results in Table 1, even in a case where the food product composition, that is, the chocolate, contained the laurin-based oil and fat and the cocoa butter, a combined use of the sucrose fatty acid ester in which a fatty acid has 18 or less carbon atoms and the sorbitan fatty acid ester could prevent the generation of a fat bloom for a long period of time very suitably.

In the related art, in a case where a cocoa butter is used together with a laurin-based oil and fat, since a fat bloom is easily generated, an addition amount of the cocoa butter has been limited. However, in the food product composition and the chocolate according to the present embodiment, since the effect of preventing a fat bloom is very high, it is possible to add a larger amount of cocoa butter than in the related art.

Although the present invention has been described in detail with reference to the specific embodiment, it will be apparent to those skilled in the art that various changes and modifications can be made without departing from the spirit and scope of the present invention.

1. A food product composition comprising: a sucrose fatty acid ester in which a fatty acid has 18 or less carbon atoms; a sorbitan fatty acid ester; a laurin-based oil and fat; and a cocoa butter.

2. The food product composition according to claim 1, wherein the sucrose fatty acid ester has an HLB value of 5 or less.

3. The food product composition according to claim 1, wherein the sorbitan fatty acid ester has an HLB value of 5 or less.

4. The food product composition according to claim 1, wherein the sucrose fatty acid ester is a sucrose laurate.

5. The food product composition according to claim 4, wherein a mass ratio of a content of the laurin-based oil and fat to a content of the cocoa butter is 1 to 33.

6. The food product composition according to claim 4, wherein a mass ratio of a content of the sucrose laurate to a content of the sorbitan fatty acid ester is 0.1 to 10.

7. The food product composition according to claim 4, wherein a mass ratio of a total content of the sucrose laurate and the sorbitan fatty acid ester to a content of the laurin-based oil and fat is 0.002 to 10.

8. The food product composition according to claim 1, further comprising an emulsifier other than the sucrose fatty acid ester and the sorbitan fatty acid ester.

9. The food product composition according to claim 1, further comprising at least one of a saccharide and a sweetener.

10. The food product composition according to claim 1, further comprising a cocoa solid.

11. A chocolate comprising the food product composition according to claim 1.

12. A method for manufacturing the chocolate according to claim 11, comprising: a step of dissolving the sucrose fatty acid ester in which the fatty acid has 18 or less carbon atoms into a melt containing at least one of the laurin-based oil and fat and the cocoa butter, and a step of dissolving the sorbitan fatty acid ester into the melt containing at least one of the laurin-based oil and fat and the cocoa butter.
